(19) United States
(12) Patent Application Publication
(10) Pub. No.: US 2017/0043296 A1
(43) Pub. Date: Feb. 16, 2017

(54) INTEGRATED WELDED WATERWAY STRUCTURE OF A REVERSE OSMOSIS WATER FILTRATION DEVICE

(71) Applicant: Xiamen Runner Industrial Corporation, Xiamen (CN)

(72) Inventors: Fang-bin Su, Xiamen (CN); Jing-ming Li, Xiamen (CN); Mang Lu, Xiamen (CN)

(21) Appl. No.: 15/231,758

(22) Filed: Aug. 8, 2016

(30) Foreign Application Priority Data
Aug. 12, 2015 (CN) 201520600978.1

(51) Int. Cl. B01D 61/08; B01D 61/02; C02F 1/44

(52) U.S. Cl. CPC B01D 61/08; C02F 1/441; B01D 61/025; C02F 2201/002

(57) ABSTRACT

An integrated welded waterway structure of a reverse osmosis (RO) water filtration device includes a mounting base, a welded inlet plate assembly, a welded outlet plate assembly mounted on the mounting base through hot plate welding. Water to be filtered sequentially goes through a water inlet of the welded inlet plate assembly, a front cartridge inlet and a front cartridge outlet of a front cartridge, a water inlet and a water outlet of the pump, a RO water inlet of a RO filter cartridge through a RO water channel of the mounting base, a RO water outlet of the RO filter cartridge, a check valve and a flowmeter of the welded outlet plate assembly, a back cartridge inlet and a back cartridge outlet of a back cartridge, and a filtered water outlet of the welded outlet plate assembly to get the water filtered.

### BACKGROUND OF THE INVENTION

Field of the Invention

The present invention relates to a reverse osmosis (RO) water filtration device and, more particularly, to an integrated welded waterway structure of a RO water filtration device.

Description of The Related Art

Reverse osmosis (RO) is a water purification technology that uses an applied pressure to unpurified water to overcome osmotic pressure and filters the unpurified water through physical property to produce drinking water without having to add any chemicals.

As having water channels connected among the filter cores through tube connection, the conventional RO water filtration devices in the market have diversified filtration functions, which result in complex waterways, increasing number of water tubes and connectors, sizable filtration devices, and leaking issue.

### SUMMARY OF THE INVENTION

In view of the problems and drawbacks of the prior art, the objective of the present invention is to provides an integrated welded waterway structure of an RO (reverse osmosis) water filtration device with reduced tube connection, less time and effort for product assembly, and make product more compact and simplified.

To achieve the foregoing objective, the RO water filtration device includes a mounting base, a welded inlet plate assembly, a pump, multiple tube, a welded outlet plate assembly, a front cartridge, a pump motor, a RO filter cartridge, a back cartridge.

The mounting base is hollow and has a bottom portion, is located at a top portion of the RO water filtration device, and has a front filtration channel system and a back filtration channel system formed in the mounting base.

The welded inlet plate assembly includes a water inlet. Water to be filtered enters the mounting base through the water inlet.

The pump has a pump inlet and a pump outlet, the pump inlet is connected with the welded inlet plate assembly through a tube, and the pump outlet is connected with the welded outlet plate assembly through a tube. The tubes are PE tubes.

The welded outlet plate assembly includes a waste water outlet, a filtered water outlet and a stored water outlet. Waste water flows out through the waste water outlet. The stored water outlet is connected with a pressure tank. Filtered water flows out through the filtered water outlet.

The front cartridge is mounted through the bottom portion of the mounting base and has a front cartridge inlet and a front cartridge outlet. The front cartridge inlet serves for water entering the front cartridge to flow therein. The front cartridge outlet serves for water filtered by the front cartridge to exit therefrom.

The pump motor is mounted through the bottom portion of the front cartridge, boosts pressure of water therein to a specific pressure, and has a pump motor inlet and a pump motor outlet. The pump motor outlet serves for the water with the boosted pressure to exit therefrom.

The RO filter cartridge is mounted through the bottom portion of the mounting base and has a RO water inlet, a RO water outlet and a RO waste water outlet. The RO water inlet is connected with the pump motor through a RO water channel of the mounting base for the water with the pressure boosted by the pump motor to flow therein. The RO water outlet serves for water filtered by the RO filter cartridge to exit therefrom. The RO waste water outlet is connected with the waste water outlet of the welded outlet plate assembly.

The back cartridge is mounted through the bottom of the mounting base and has a back cartridge inlet and a back cartridge outlet. The back cartridge inlet is connected with the RO filter cartridge through the back filtration channel system of the mounting base. The back cartridge outlet is connected to the filtered water outlet of the welded outlet plate assembly for water filtered by the back cartridge to exit from the mounting base.

When compared to conventional techniques, the present invention has the following advantages, namely, small size, closely arranged structure and easy installation. The integrated welded waterway structure adopts multiple water inlet elements, the pump, and multiple water outlet elements to form a complete filtration waterway structure. Moreover, using the welded outlet plate assembly can be interchanged between the 75G and 500G waterways. Because the integrated welded waterway structure do not use large amount of tubes for waterway connection, assembly time of the product is reduced, water leakage can be avoided, and the reliability and safety of the RO water filtration device can be enhanced.

### BRIEF DESCRIPTION OF THE DRAWINGS

The detailed description of the drawings particularly refers to the accompanying figures in which:

FIG. 1 is a perspective view of an integrated and welded waterway structure of a RO water filtration device in accordance with the present invention;

FIG. 2 is a partially enlarged perspective view of a welded inlet plate assembly in FIG. 1;

FIG. 3 is a partially enlarged perspective view of a welded outlet plate assembly in FIG. 1;

FIG. 4 is a partially enlarged perspective view of a water outlet plate in FIG. 3;

FIG. 5 is a cross-sectional view of the water outlet plate in FIG. 4;

FIG. 6 is an operational perspective view of the integrated and welded waterway structure in FIG. 1;

FIG. 7 is a cross-sectional view of the integrated and welded waterway structure in FIG. 6;

FIG. 8 is an enlarged cross-sectional view of a portion of the integrated and welded waterway structure circled by letter F in FIG. 7;

FIG. 9 is an operational functional block diagram of the integrated and welded waterway structure in FIG. 1;

FIG. 10 is a perspective view of a first embodiment of an integrated and welded waterway structure in accordance with the present invention;

FIG. 11 is a partially exploded perspective view of a welded inlet plate assembly in FIG. 10;

FIG. 12 is an enlarged perspective view of the welded inlet plate assembly circled by letter A in FIG. 11;

FIG. 13 is an exploded perspective view of a welded outlet plate assembly in FIG. 10;

FIG. 14 is an enlarged perspective view of the welded outlet plate assembly circled by letter B in FIG. 13;

FIG. 15 is a first perspective view of a water outlet plate in FIG. 13;

FIG. 16 is a second perspective view of the water outlet plate in FIG. 13;

FIG. 17 is an enlarged perspective view of the welded outlet plate assembly circled by letter C in FIG. 13;

FIG. 18 is a bottom view of the water outlet plate in FIG. 13;

FIG. 19 is a perspective view of a second embodiment of an integrated and welded waterway structure in accordance with the present invention;

FIG. 20 is an exploded perspective view of a welded inlet plate assembly in FIG. 19;

FIG. 21 is an enlarged perspective view of a water inlet plate circled by letter A in FIG. 20;

FIG. 22 is an exploded perspective view of the welded outlet plate assembly in FIG. 19;

FIG. 23 is an enlarged perspective view of a welded outlet plate circled by letter B in FIG. 22;

FIG. 24 is a perspective view of a third embodiment of an integrated and welded waterway structure in accordance with the present invention;

FIG. 25 is an exploded perspective view of the welded outlet plate assembly in FIG. 19;

FIG. 26 is an enlarged perspective view of a water outlet plate circled by letter C in FIG. 25;

FIG. 27 is a cross-sectional view of the water outlet plate in FIG. 18; and

FIG. 28 is a perspective view of a bottom of the water outer plate in FIG. 18.

### DETAILED DESCRIPTION OF THE INVENTION

The purpose, construction, features, functions and advantages of the present invention can be appreciated and understood more thoroughly through the following detailed description with reference to the attached drawings.

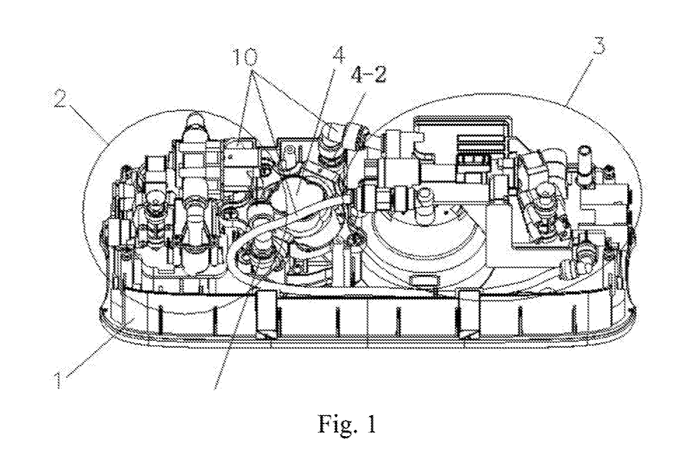

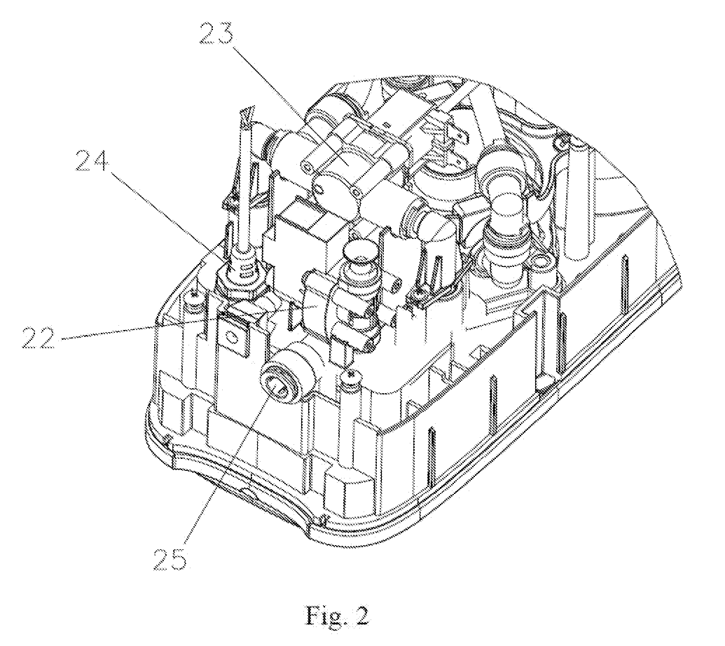

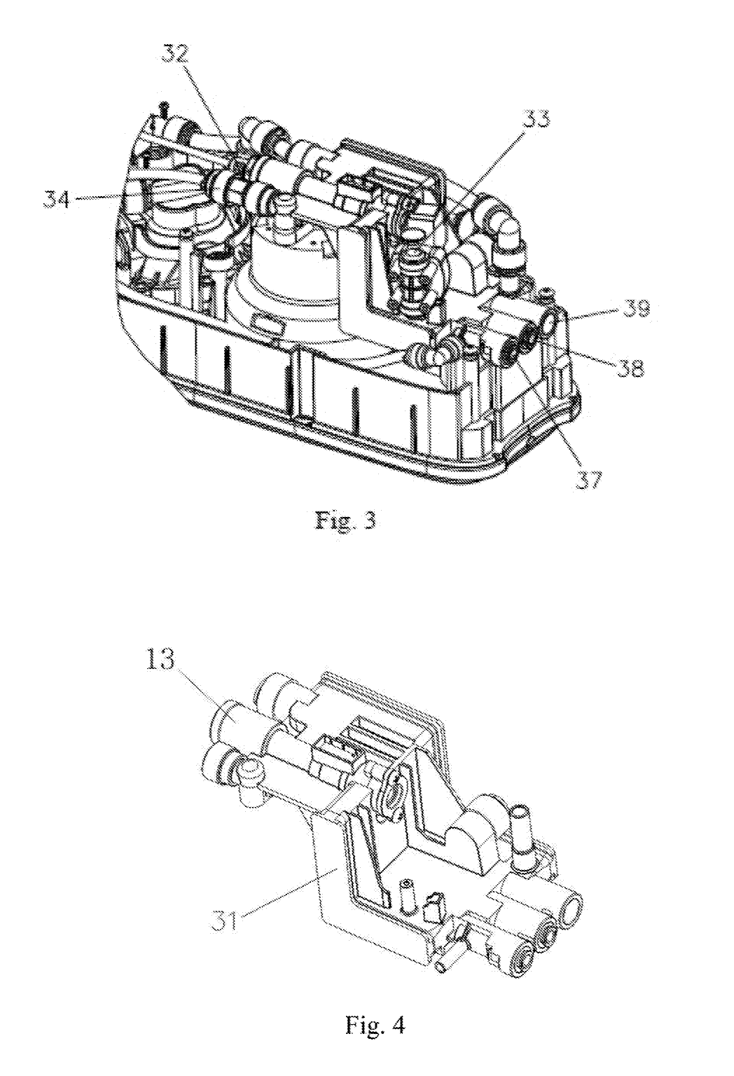

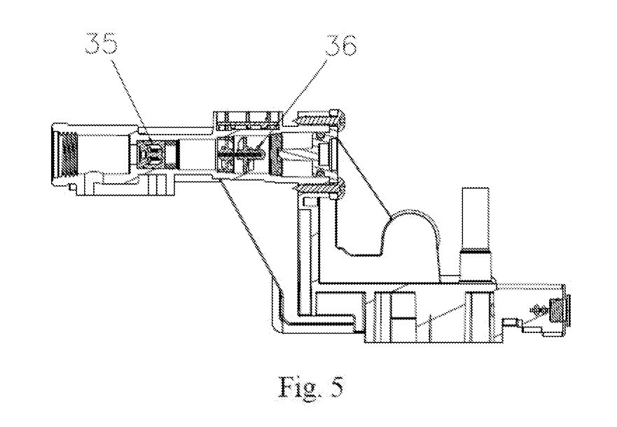

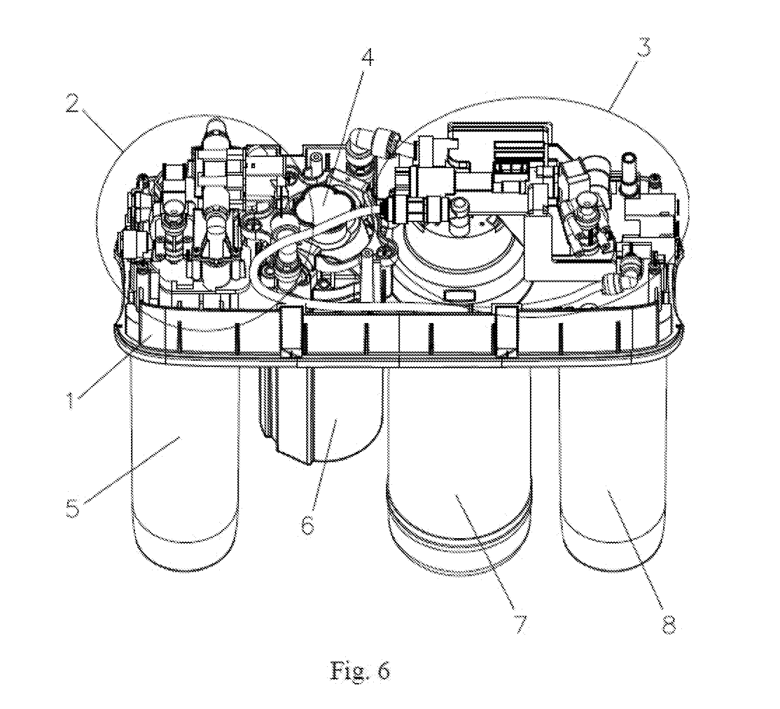

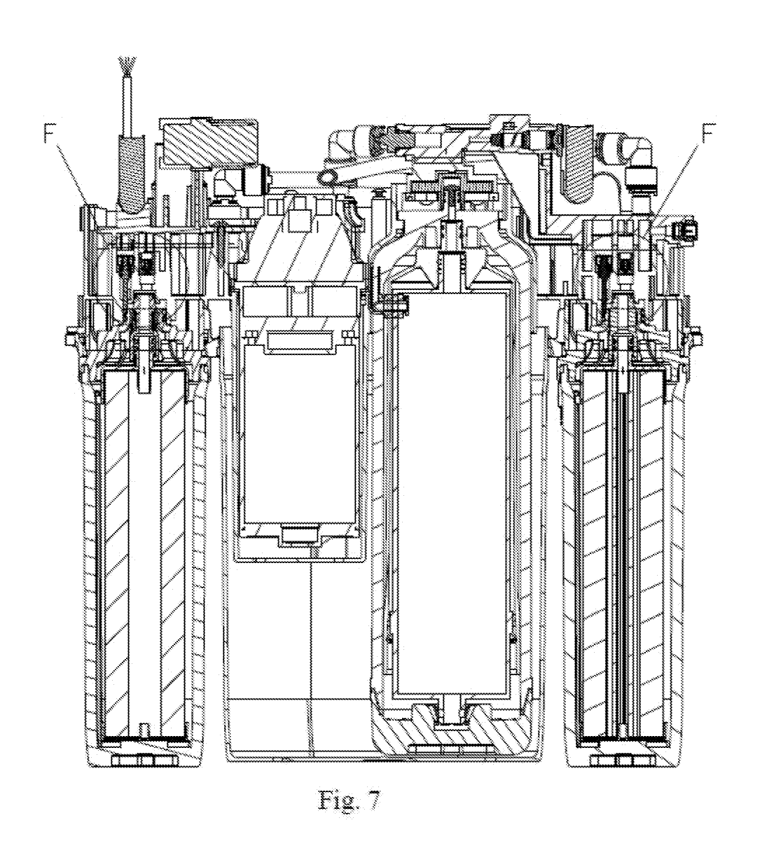

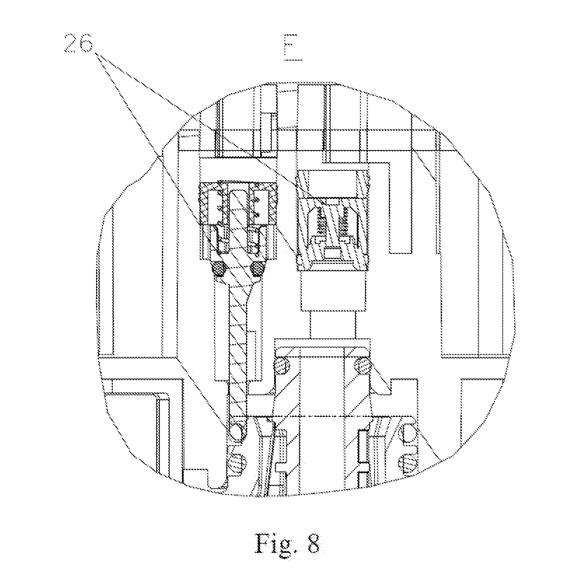

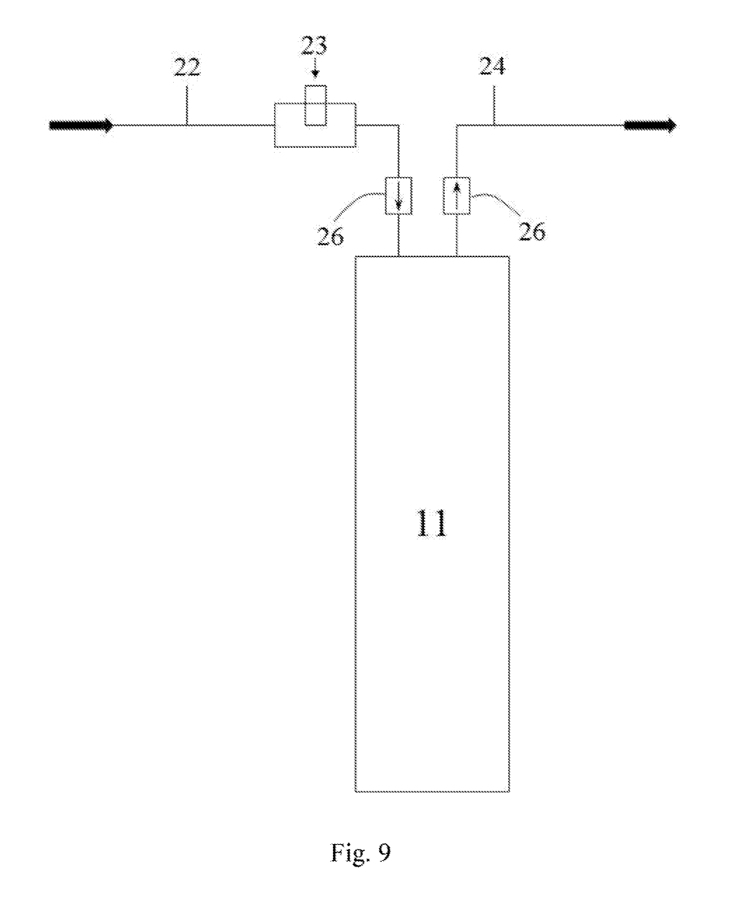

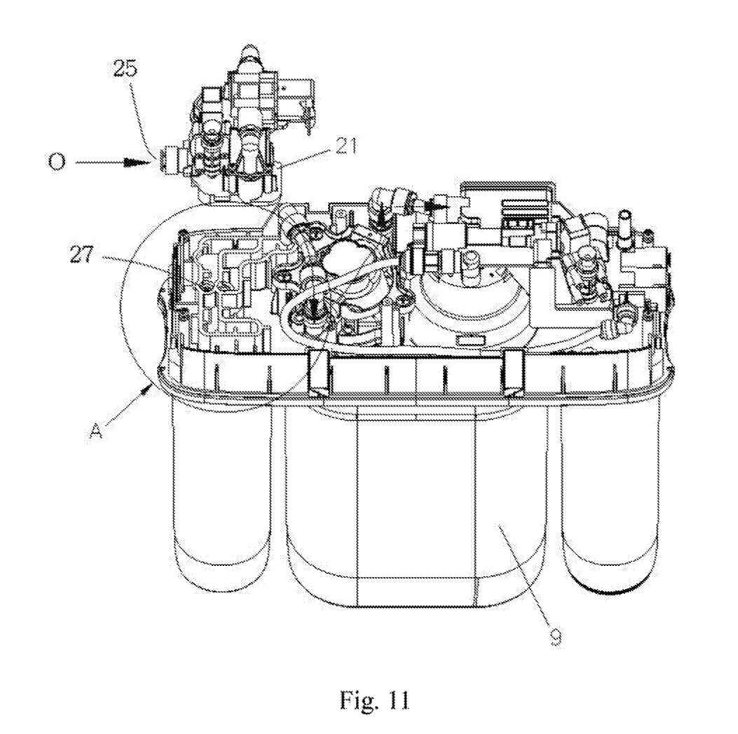

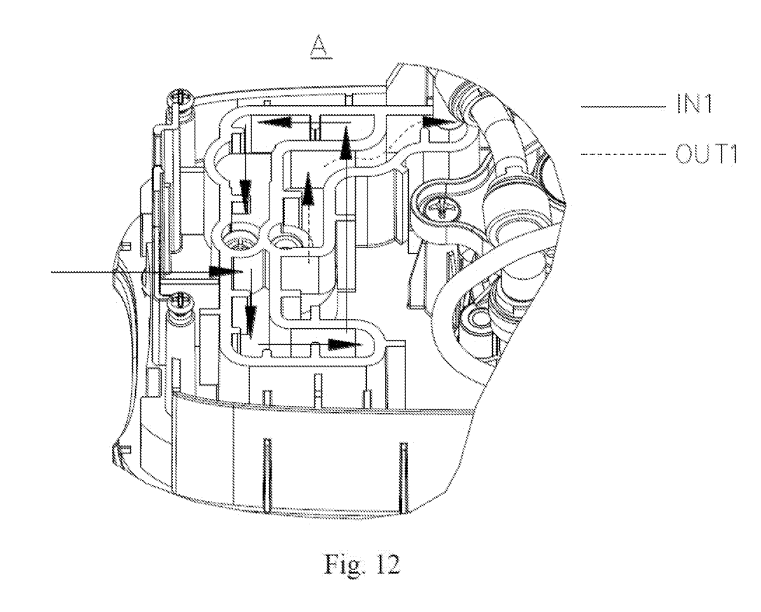

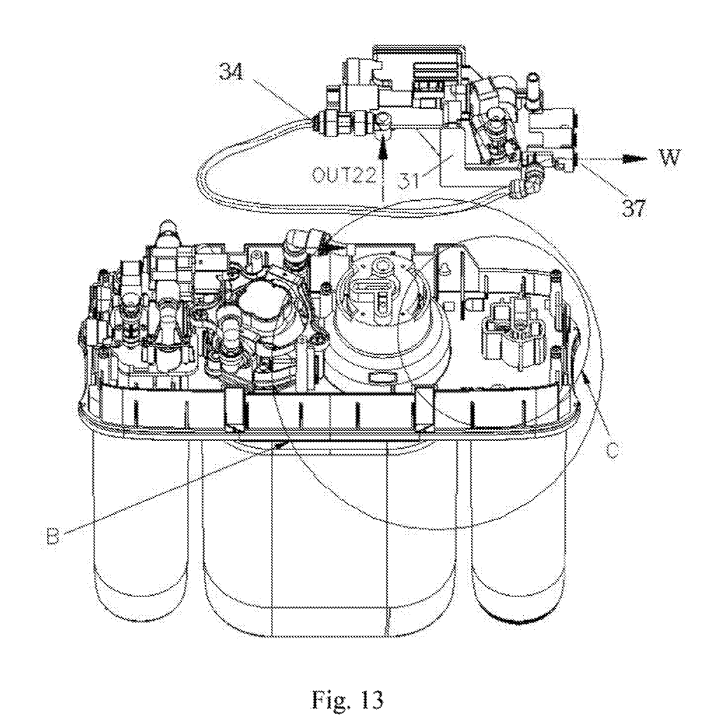

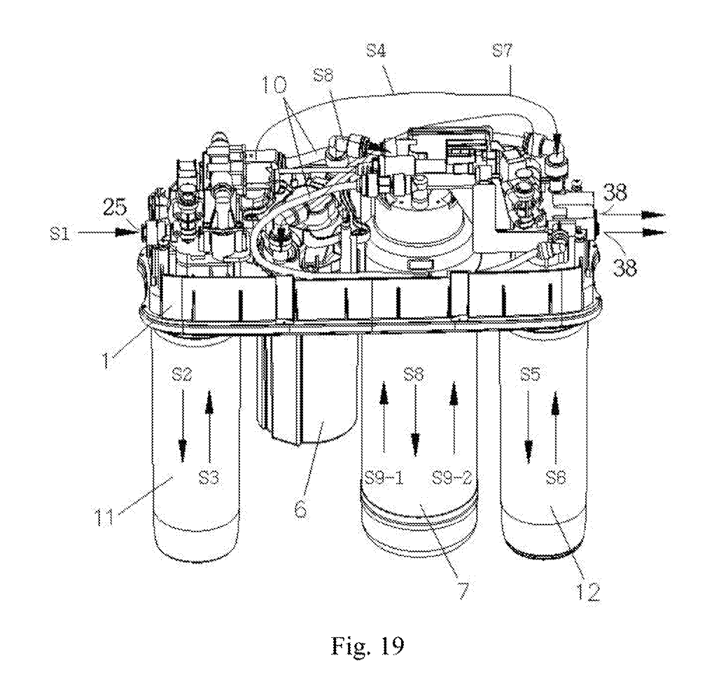

With reference to FIGS. 1 to 13, an integrated welded waterway structure of a RO water filtration device in accordance with the present invention includes a mounting base 1, a welded inlet plate assembly 2, a pump 4, multiple tubes 10, a welded outlet plate assembly 3, a front cartridge 5, a pump motor 6, a RO filter cartridge 7, a back cartridge 8, a shell 9, a first cartridge 11, a second cartridge 12 (With reference to FIG. 19), a RO water channel 13, a front filtration channel system A and a back filtration channel system B.

The mounting base 1 is hollow and is located at a top portion of the integrated welded waterway structure.

The welded inlet plate assembly 2 is mounted on a top portion of the mounting base 1 through hot plate welding and includes a water inlet 25, a water inlet plate 21, and a check valve assembly 26. Water to be filtered enters the water inlet 25. The water inlet plate 21 has one or a combination of a low-pressure switch 22, an inlet solenoid valve 23, an inlet TDS (total dissolved solids) transducer 24 and a front cartridge inlet 27.

The pump 4 is mounted on the top portion of the mounting base 1 and has a pump inlet 4-1 and a pump outlet 4-2, the pump inlet 4-1 is connected with the welded inlet plate assembly 2 through one of the tubes 10, and the pump outlet 4-2 is connected with the welded outlet plate assembly 3 through another one of the tubes 10. The pump 4 differs from regular booster pump and is preferably a pressure regulator supplying stable water pressure of water flow into welded outlet plate assembly 3 to avoid drastic fluctuation of output water pressure of the pump 4. The tubes 10 may be PE (Pressure Equalization) tubes.

The welded outlet plate assembly 3 is mounted on the top portion of the mounting base 1 through hot plate welding and includes a water outlet plate 31, a waste water outlet 37, a filtered water outlet 38 and a stored water outlet 39. The stored water outlet 39 is connected with a pressure tank. The water outlet plate 31 has one or a combination of a water outlet TDS transducer 32, a high-pressure switch 33, a flow restrictor 34, a check valve 35 and a flowmeter 36.

The front filtration channel system A, the back filtration channel system B and the RO water channel 13 are formed on the top portion of the mounting base 1.

### Embodiment 1

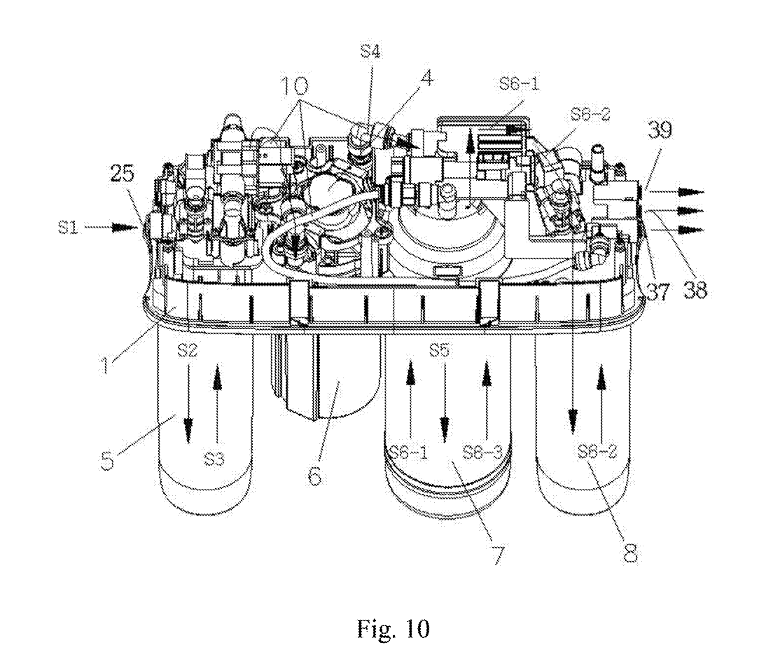

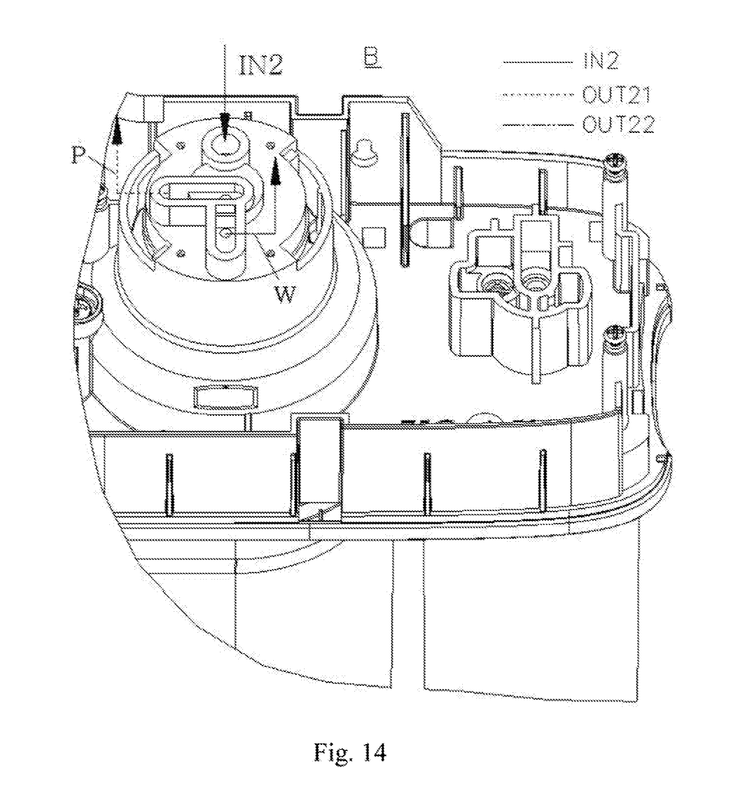

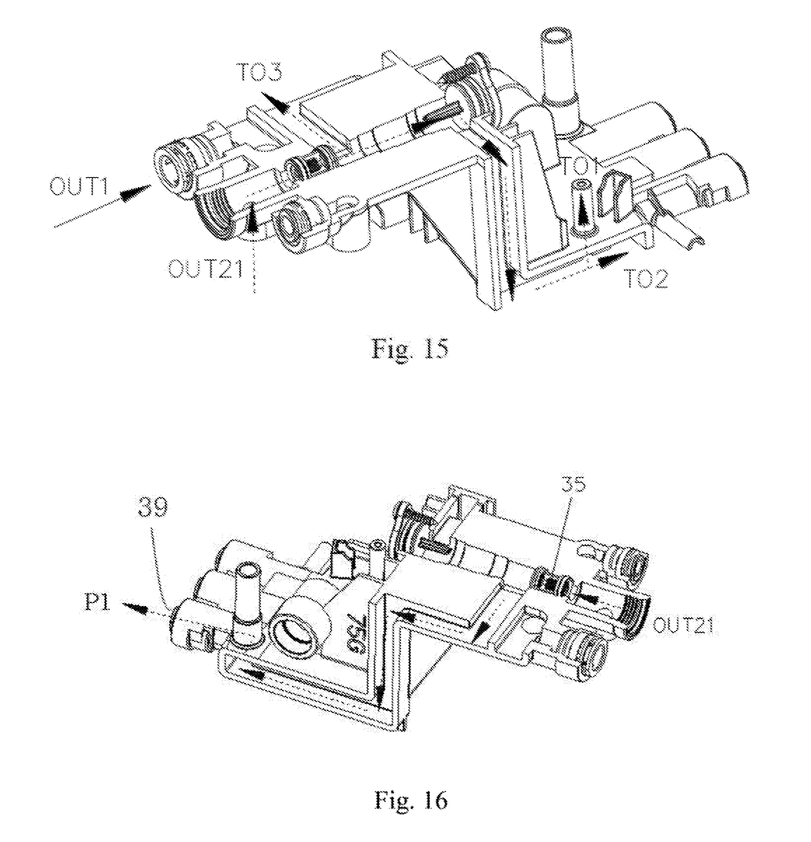

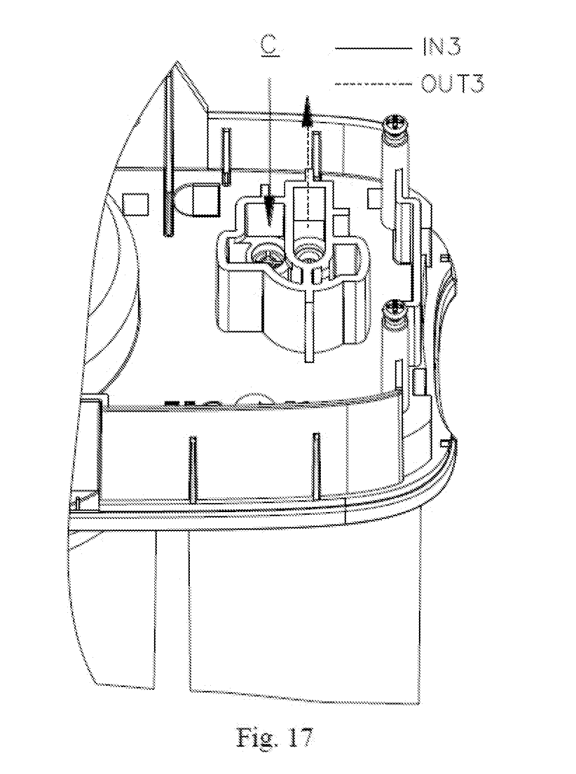

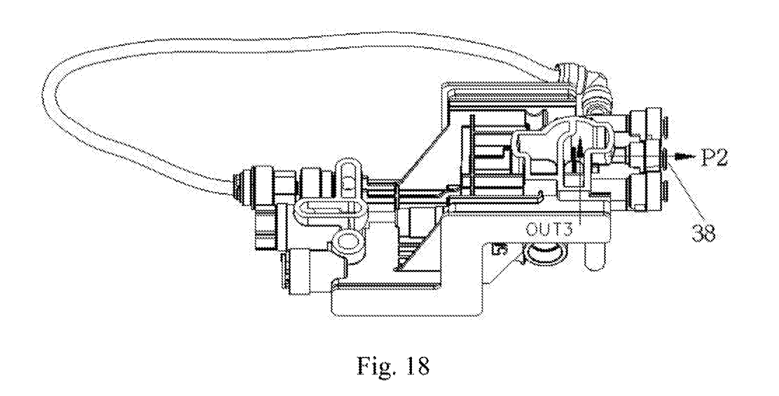

With reference to FIGS. 10 to 18, the front cartridge 5, the pump motor 6, the RO filter cartridge 7 and the back cartridge 8 are mounted through a bottom portion of the mounting base 1. The front cartridge 5 is preferably a PE/GAC (pressure equalization and granular activated carbon) compound cartridge. The front cartridge 5 has an inlet and outlet. The inlet is connected with the front cartridge inlet 27. The outlet is connected with a corresponding tube 10.

The pump motor 6 is located between the front cartridge 5 and the RO filter cartridge 7, and has a pump inlet and a pump outlet connected with two corresponding tubes 10. The pump motor 6 serves to provide momentum required to supply stable water pressure of water flow into the RO filter cartridge 7. A top of the pump motor 6 is connected with the pump 4, water flows into the pump motor 6 through the pump inlet 4-1, and after water pressure of the pump motor 6 goes up, water flows from the pump motor 6 to the mounting base 1 through the pump outlet 4-2.

The RO filter cartridge 7 has an RO water inlet, an RO water outlet and an RO waste water outlet. The RO water inlet is connected with the RO water channel 13. Filtered water and waste water outputted from the RO filter cartridge 7 flows into the welded outlet plate assembly respectively through the RO water outlet and the RO waste water outlet. The RO water outlet is connected with the check valve 35 of the welded outlet plate assembly 3. The RO waste water outlet is connected with the waste water outlet 37 through the flow restrictor 34 of the welded outlet plate assembly 3.

The back cartridge 8 has a back cartridge inlet and a back cartridge outlet, the back cartridge inlet is connected with the flowmeter 36, and the back cartridge outlet is connected with the filtered water outlet 38 of the welded outlet plate assembly 3.

The shell 9 is mounted on the bottom portion of the mounting base 1 to enclose the pump motor 6 and the RO filter cartridge 7 in the shell 9.

Given 75G waterway as an example, with further reference operation of the 75G waterway includes the following steps.

Step S1: Water O to be filtered enters the welded inlet plate assembly 2 of the mounting base 1 through the water inlet 25, and sequentially flows through the low-pressure switch 22 and inlet solenoid valve 23.

Step S2: The water O flows into the front cartridge 5 through the front cartridge inlet 27 to be filtered.

Step S3: After filtered by the front cartridge 5, the water O flows out of the front cartridge 5.

Step S4: The water O further flows into the pump 4 to increase the pressure of the water O.

Step S5: After the pressure of the water O is increased, the water O flows into the RO filter cartridge 7 through the RO water channel 13.

Step S6: After the water O is filtrated by the RO filter cartridge 7 to generate a filtered water P, the filtered water P flow through the check valve 35 of the welded outlet plate assembly 3 is divided into a first filtered water P1 and a second filtered water P2 through two waterways respectively defined in step S6-1 and step S6-2.

Step S6-1: The first filtered water P1 enters the welded outlet plate assembly 3, flows through the high-pressure switch 33, and then enters the pressure tank for storage through the stored water outlet 39.

Step S6-2: The second filtered water P2 flows through the flowmeter 36 and then enters the back cartridge inlet of the back cartridge 8 to be filtered again to flow to a filtered water faucet through the filtered water outlet 38 of the welded outlet plate assembly 3.

Step S6-3: After the water O in the RO filter cartridge 7 is filtered, waste water W is generated, then flows through the flow restrictor 34, and flows out from the waste water outlet 37 of the welded outlet plate assembly 3.

During step 51 to step S4, water flows through the front filtration channel system A. During step S5 to step S6, water flows through the back filtration channel system B.

### Embodiment 2

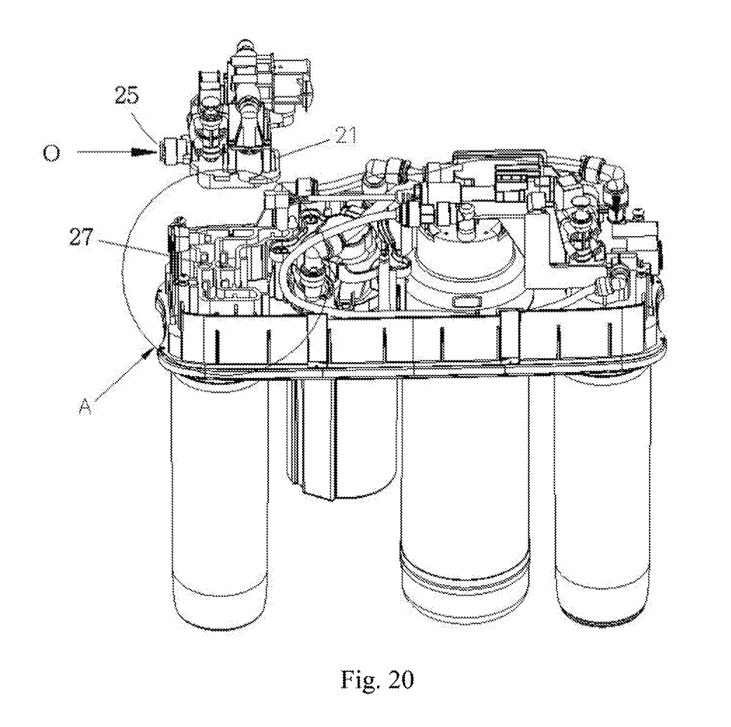

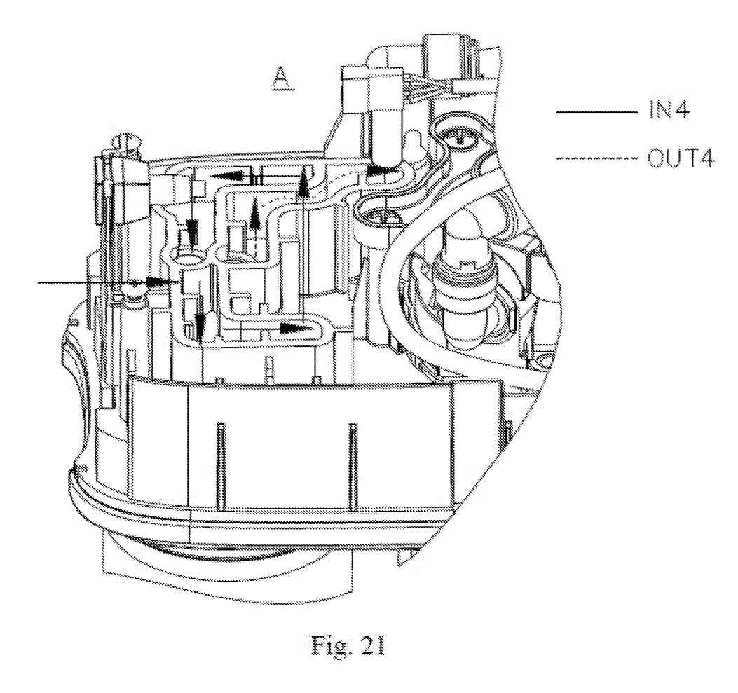

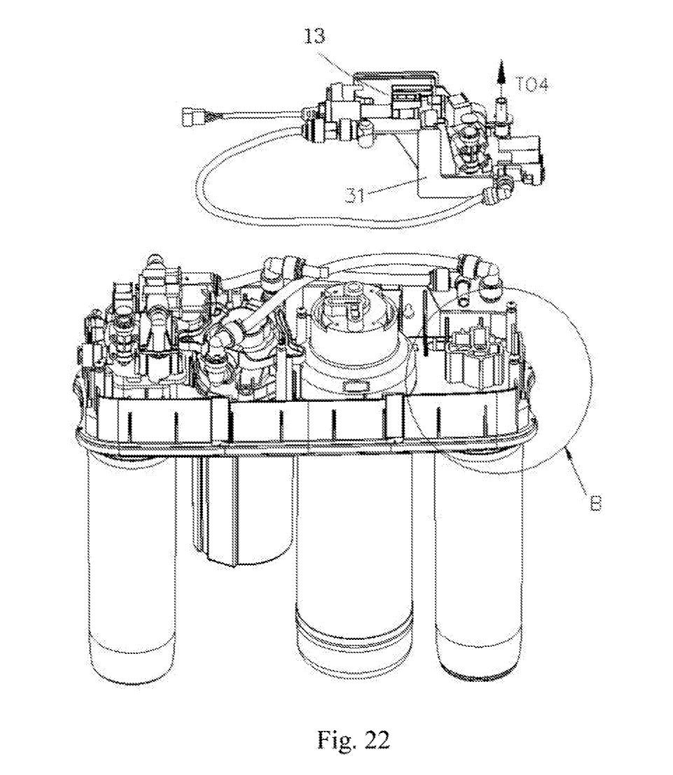

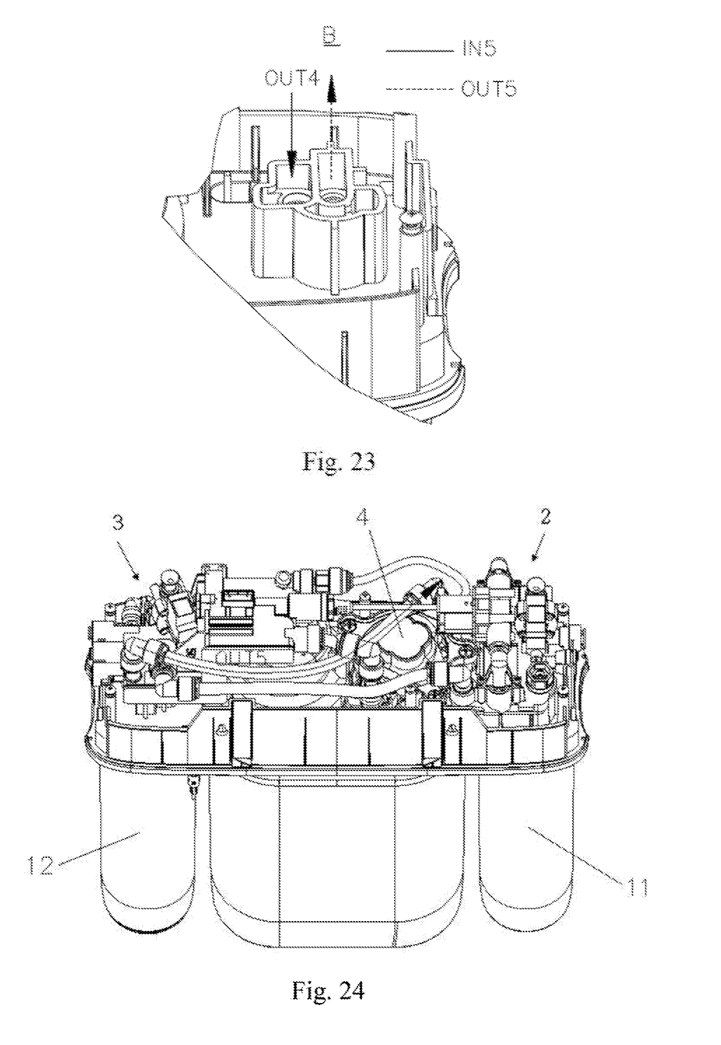

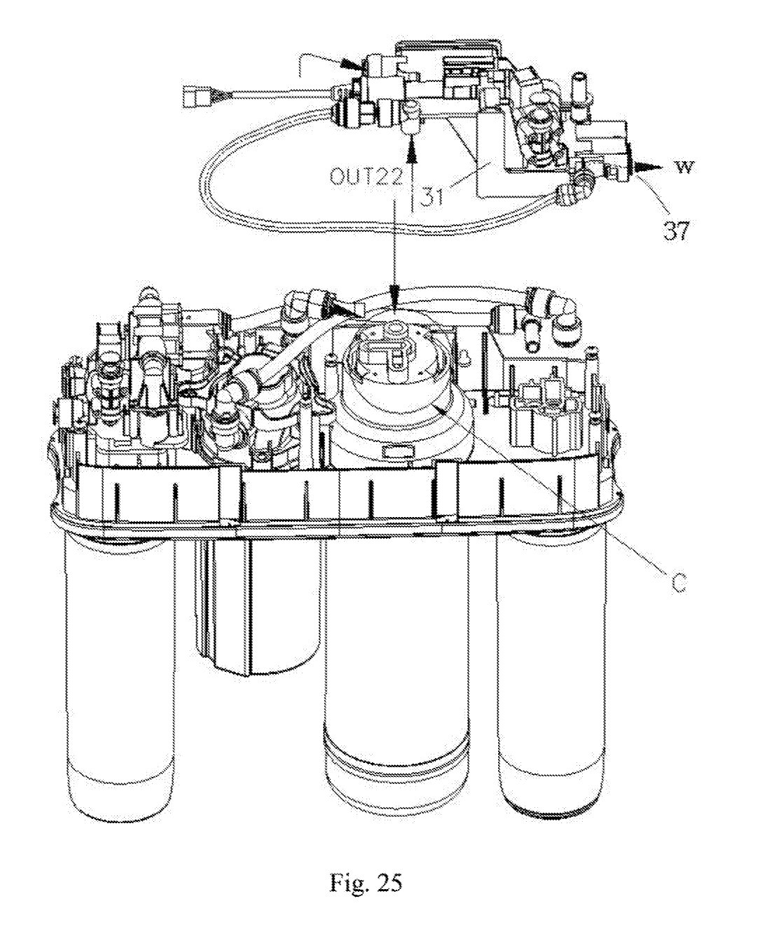

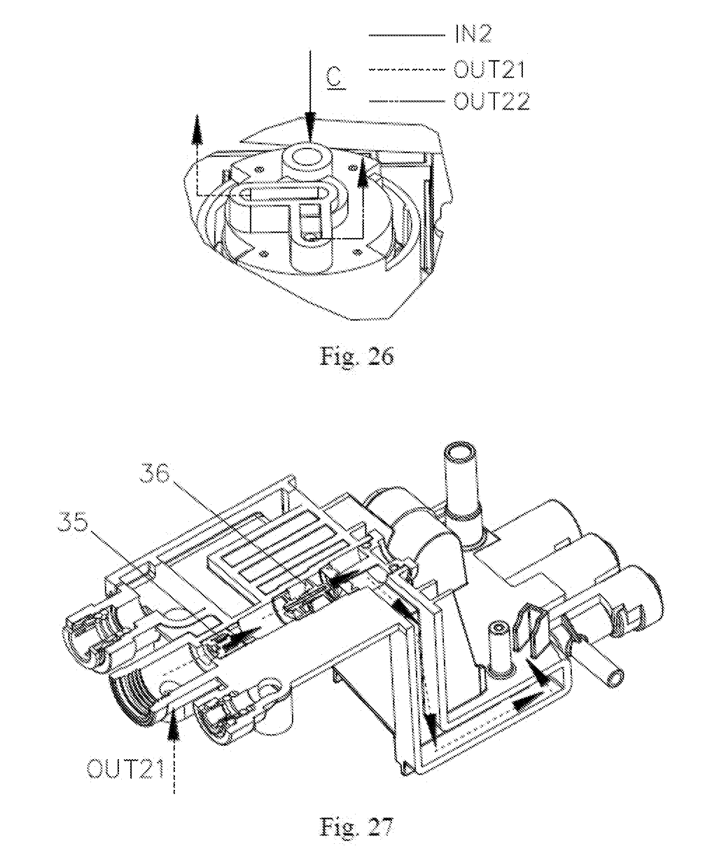

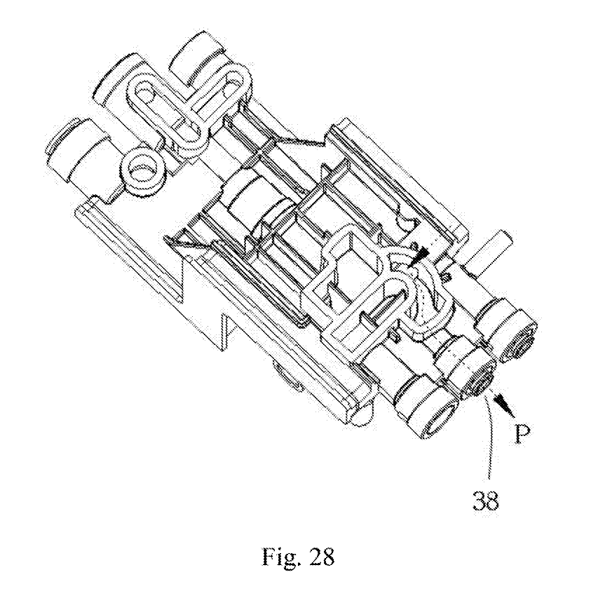

With reference to FIGS. 19 to 28, the first cartridge 11, the pump motor 6, the RO filter cartridge 7 and the second cartridge 12 are mounted through a bottom portion of the mounting base 1. The first cartridge 11 is preferably a CB (Carbon Block) cartridge and the second cartridge 12 is preferably a CB/PA compound cartridge.

The first cartridge 11 contain a first cartridge inlet and a first cartridge outlet, the first cartridge inlet is connected with the front cartridge inlet 27. The first cartridge outlet is connected with a corresponding tube 10.

The pump motor 6 is located between the first cartridge 11 and the RO filter cartridge 7, and has a pump inlet and a pump outlet. The pump inlet and the pump outlet are connected with corresponding tubes 10. The pump motor 6 serves to provide momentum required to supply stable water pressure of water flow into the RO filter cartridge 7. A top end of the pump motor 6 is connected with the pump 4. Water flows from the pump 4 to the pump motor 6 through the pump inlet 4-1. The pressurized water flows from the pump motor 6 to the mounting base 1 through the pump outlet 4-2.

The RO filter cartridge 7 has a RO water inlet, a RO water outlet and a RO waste water outlet. The RO water inlet is connected with the RO water channel 13. Filtered water and waste water outputted from the RO filter cartridge 7 respectively goes to the RO water outlet and the RO waste water outlet and flows to the welded outlet assembly 3. The RO water outlet is connected with the check valve 35 of the welded outlet plate assembly 3 of the mounting base 1. The RO waste water outlet is connected with the waste water outlet 37 of the welded outlet plate assembly 3 through the flow restrictor 34 of the water outlet plate 31.

The second cartridge 12 has a second cartridge inlet and a second cartridge outlet. The second cartridge inlet is connected with the flowmeter 36. The second cartridge outlet is connected with the filtered water outlet 38 of the welded outlet plate assembly 3.

The shell 9 is mounted on the bottom portion of the mounting base 1 to enclose the pump motor 6 and the RO filter cartridge 7 in the shell 9.

Operation of 500G waterway is described as follows step.

Step S1: Water O to be filtered enters the welded inlet plate assembly 2 through the water inlet 25, and sequentially flows through the low-pressure switch 22 and inlet solenoid valve 23.

Step S2: The water O flows in the first cartridge 11 through the front cartridge inlet 27 to be filtered.

Step S3: The water O filtered by the first cartridge 11 flows out of the first cartridge 11 through the first cartridge outlet.

Step S4: The water O flows into the RO water channel 13.

Step S5: The water O flows into the second cartridge 12 to be filtered again.

Step S6: The water O filtered by the second cartridge 12 flows out of the second cartridge 12, and flows into the RO water channel 13.

Step S7: The water O flows into the pump 4 to increase the pressure of the water O.

Step S8: The water O with boosted pressure, then flows into the RO filter cartridge 7 through the RO water channel 13.

Step S9: After passing the check valve 35, the water O filtrated by the RO filter cartridge 7 is divided into filtered water P and waste water W.

Step S9-1: The filtered water P sequentially flows through the water outlet TDS transducer 32, the check valve 35 and the flowmeter 36 of the welded outlet plate assembly 3 and then flows to a filtered water faucet through the filtered water outlet 38 of the welded outlet plate assembly 3.

Step S9-2: the waste water W generated by the RO filter cartridge 7 flows through the flow restrictor 34 and then flows out from the waste water outlet 37 of the welded outlet plate assembly 3.

During step S1 to step S7, water flows through the front filtration channel system A. During step S8 to step S9, water flows through the back filtration channel system B. The front filtration channel system A includes a first filtration system and a second filtration system. During step S1 to step S4, water flows through the first filtration system. During step S4 to step S7, water flows through the second filtration system.

What is claimed is:

1. An integrated welded waterway structure of a reverse osmosis (RO) water filtration device, comprising:
a mounting base located at a top portion of the RO water filtration device and having a front filtration channel system formed in the mounting base;
a welded inlet plate assembly mounted on a top portion of the mounting base through hot plate welding and having a water inlet for water to be filtered to enter;
a RO water channel formed on the top portion of the mounting base;
a welded outlet plate assembly mounted on the top portion of the mounting base and having a waste water outlet for waste water to flow out and a filtered water outlet for filtered water to flow out;
a pump mounted on the top portion of the mounting base, boosting pressure of the water to be filtered, and having a pump inlet and a pump outlet, wherein the pump inlet is connected with the welded inlet plate assembly and the pump outlet is connected with the welded outlet plate assembly through tubes.

2. The integrated welded waterway structure as claimed in claim 1, wherein the welded inlet plate assembly includes a water inlet plate and a check valve assembly, and the water inlet plate has one or a combination of a low-pressure switch, an inlet solenoid valve and an inlet total dissolved solids (TDS) transducer.

3. The integrated welded waterway structure as claimed in claim 1, wherein the welded outlet plate assembly includes a water outlet plate having one or a combination of a water outlet total dissolved solids (TDS) transducer, a high-pressure switch, a flow restrictor, a check valve and a flowmeter.

4. The integrated welded waterway structure as claimed in claim 1, wherein, the front filtration channel system includes a first filtration system and a second filtration system.

5. The integrated welded waterway structure as claimed in claim 1, further comprising a back filtration channel system for filtering water filtered by the front filtration channel system.

6. The integrated welded waterway structure as claimed in claim 1, wherein the welded outlet plate assembly has a stored water outlet connected with a pressure tank.

7. The integrated welded waterway structure as claimed in claim 1, wherein the pump is a pressure regulator.

8. The integrated welded waterway structure as claimed in claim 1, wherein the tubes are PE (Pressure Equalization) tubes.
